(19) United States
(12) Patent Application Publication
(10) Pub. No.: US 2014/0164367 A1
(43) Pub. Date: Jun. 12, 2014

(54) METHOD AND SYSTEM FOR SEMANTIC SEARCH KEYWORD RECOMMENDATION

(71) Applicant: Electronics and Telecommunications Research Institute, Daejeon (KR)

(72) Inventor: Moo Hun LEE, Daejeon (KR)

(73) Assignee: Electronics and Telecommunications Research Institute, Daejeon (KR)

(21) Appl. No.: 14/102,110

(22) Filed: Dec. 10, 2013

(30) Foreign Application Priority Data
Dec. 11, 2012 (KR) 10-2012-0143755

(51) Int. Cl. G06F 17/30

(52) U.S. Cl. CPC G06F 17/30634
USPC 707/723; 707/758

(57) ABSTRACT

Provided is a keyword recommendation system. The keyword recommendation system may include a recognition unit to recognize an entity corresponding to an input keyword input from a user, a search unit to search for a plurality of triple data associated with the entity, an extraction unit to extract at least one recommended keyword by processing the plurality of triple data, a providing unit to provide the at least one recommended keyword, and a calculation unit to calculate a weight value for the at least one recommended keyword.

### CROSS-REFERENCE TO RELATED APPLICATION

This application claims priority to and the benefit of Korean Patent Application No. 10-2012-0143755, filed on Dec. 11, 2012, in the Korean Intellectual Property Office, the disclosure of which is incorporated herein by reference.

### BACKGROUND

1. Field of the Invention

Exemplary embodiments relate to a method of recommending a search keyword, and more particularly, to a system for recommending a semantic search keyword that may receive an input keyword from a user, may recognize an entity based on a knowledge base, may search the knowledge base from the recognized entity, and may recommend a search keyword in a suitable pattern for semantic search.

2. Description of the Related Art

Due to a diverse number of personal devices, for example, smart phones, smart TVs, and the like, users are able to search for information through various devices. The information searched for via these personal devices addresses different requirements to those of a traditional personal computer (PC)-based information search.

A web search engine typically used for an information search works based on a keyword-based search, and is designed to collect documents on the web, index words appearing with great frequency on the corresponding documents, and locate a document including a greatest number of identical words to a keyword input from a user. In such an information search system, a recall rate is high because only a document including an identical word to a keyword input from a user is found, absent consideration of a meaning of the input keyword. However, a precision rate is low. More particularly, a proportion of retrieved documents closely relevant to the meaning of the input keyword is low.

To resolve this issue, a semantic search technique using semantics is proposed. The semantic search provides accurate search results consistent with the intent of a user through an understanding of contextual meanings of terms, based on a knowledge base for generating relevant search results.

Also, users well acquainted with a keyword-based search have difficulties in configuring a query for a semantic search due to a lack of understanding as to a knowledge base. A method of recommending a search keyword may aid a user in configuring a suitable query for conducting a semantic search by recommending a semantic search keyword to the user.

### SUMMARY

According to an aspect of the present invention, there is provided a keyword recommendation system including a recognition unit to recognize an entity corresponding to an input keyword input from a user, a search unit to search for a plurality of triple data associated with the entity, an extraction unit to extract at least one recommended keyword by processing the plurality of triple data, and a providing unit to provide the at least one recommended keyword.

The keyword recommendation system may further include a calculation unit to calculate a weight value for the at least one recommended keyword. The providing unit may provide the at least one recommended keyword by arranging the at least one recommended keyword based on the calculated weight value.

The calculation unit may calculate the weight value based on a number of appearances of the at least one recommended keyword.

The recognition unit may recognize the entity corresponding to the input keyword by referring to label index information stored in a knowledge base for the system.

The search unit may search for a plurality of triple data having the entity as a subject among a plurality of triple data stored in a knowledge base for the system. The plurality of triple data may include a subject, a predicate, and an object, and the search unit may search for a plurality of triple data having an identical subject to the entity among the plurality of triple data stored in the knowledge base.

The extraction unit may process the plurality of triple data by extracting a representative property of a predicate among words included in the plurality of triple data. The extraction unit may process the plurality of triple data by extracting a representative type of an object among words included in the plurality of triple data.

According to another aspect of the present invention, there is provided a keyword recommendation method including receiving an input keyword from a user, recognizing an entity corresponding to the input keyword, searching for a plurality of triple data associated with the recognized entity, extracting at least one recommended keyword by processing the plurality of triple data, calculating a weight value for the at least one recommended keyword, and providing the at least one recommended keyword.

The recognizing of the entity may include recognizing the entity corresponding to the input keyword by referring to label index information stored in a knowledge base.

The calculating of the weight value may include calculating the weight value based on a number of appearances of the at least one recommended keyword.

The providing of the at least one recommended keyword may further include arranging the at least one recommended keyword based on the calculated weight value.

The plurality of triple data stored in the knowledge base may include a subject, a predicate, and an object, and the searching for the plurality of triple data may include searching for, among a plurality of triple data stored in a knowledge base, a plurality of triple data having the entity as a subject, and searching for a plurality of triple data having an identical subject to the entity.

The extracting of the at least one recommended keyword may include processing the plurality of triple data by extracting a representative property of a predicate and a representative type of an object among words included in the plurality of triple data.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a keyword recommendation system according to an exemplary embodiment;

FIG. 2 is a flowchart illustrating a method of recommending a keyword according to an exemplary embodiment;

FIG. 3 is a diagram illustrating an entire configuration of a keyword recommendation system according to an exemplary embodiment;

FIG. 4 is block diagram illustrating a keyword recommendation management unit of the system of FIG. 3;

FIG. 5 is block diagram illustrating a knowledge base management unit and a knowledge base of the system of FIG. 3; and

FIG. 6 is a block diagram for recommending a keyword according to an exemplary embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein.

The examples used herein are intended merely to facilitate an understanding of ways in which the embodiments herein can be practiced and to further enable those of skill in the art to practice the embodiments herein. Accordingly, the examples should not be construed as limiting the scope of the embodiments herein. Like reference numerals refer to the like elements throughout.

Dissimilar to keyword-based search requiring an input of a keyword alone, a semantic search further requires an input of additional information for defining a meaning to facilitate correct interpretation for providing a more accurate search result. However, users accustomed to keyword-based search have difficulties in setting a suitable keyword for conducting a semantic search that may lead to accurate search results.

When a user is provided with a semantic search keyword recommended based on a knowledge base, the user may obtain accurate search results consistent with an intent of the user.

A conventional search keyword recommendation method is implemented based on a keyword-based search system, and the keyword-based search system is provided in a form of a search keyword recommendation method and a relevant search keyword recommendation method.

The search keyword recommendation method functions through collecting keywords input from users and providing a frequently used search pattern. The relevant search keyword recommendation method functions through collecting and indexing documents on the web, for example, webpages, measuring similarity between words of high appearance, storing the documents and measured similarity, and providing a relevant search keyword in response to a particular word being input.

As described in the foregoing, the conventional search keyword recommendation method recommends a keyword based on a number of appearances of a search keyword or similarity between words in a document because of being based on a keyword-based search system. However, this mechanism is unsuitable for a semantic search system. Accordingly, there is a demand for a new method of recommending a search keyword for semantic search.

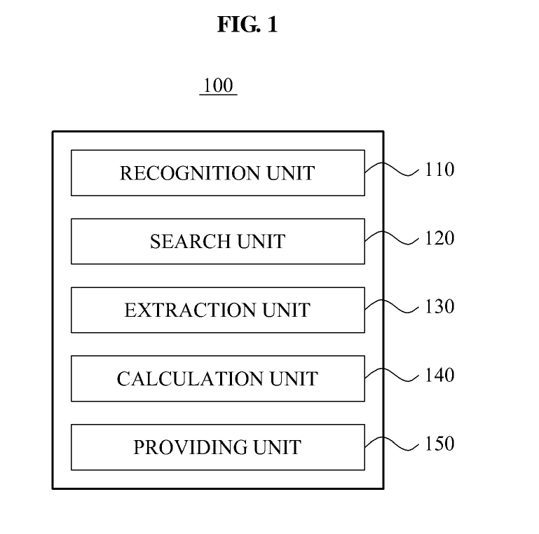

FIG. 1 is a block diagram illustrating a keyword recommendation system 100 according to an exemplary embodiment.

Referring to FIG. 1, the keyword recommendation system 100 may include a recognition unit 110, a search unit 120, an extraction unit 130, and a providing unit 150. The recognition unit 110 may recognize an entity corresponding to an input keyword input from a user. The search unit 120 may search for a plurality of triple data associated with the entity. The extraction unit 130 may extract at least one recommended keyword by processing the plurality of triple data. The providing unit 150 may provide the at least one recommended keyword.

Also, the system 100 may further include a calculation unit 140 to calculate a weight value for each of the at least one recommended keyword, and the providing unit 150 may arrange the at least one recommended keyword based on the calculated weight value and may provide the user with the at least one recommended keyword.

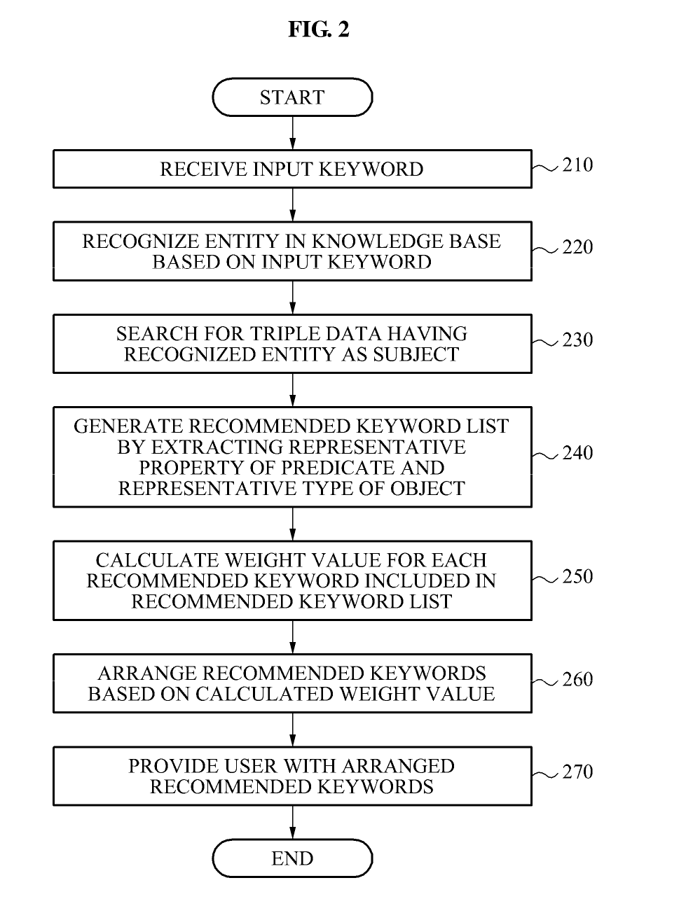

The calculation unit 140 may calculate the weight value for each of the at least one recommended keyword based on a number of times the at least one recommended keyword appears in a knowledge base. A further detailed description is provided with reference to FIG. 2.

More particularly, the recognition unit 110 may recognize an entity corresponding to the input keyword by referring to label index information stored in the knowledge base for the system 100. Subsequently, the search unit 120 may search for a plurality of triple data having the entity as a subject, among the plurality of triple data stored in the knowledge base for the system 100.

According to an exemplary embodiment, the plurality of triple data may include a subject, a predicate, and an object, and the search unit 120 may search for a plurality of triple data having an identical subject to the entity. The extraction unit 130 may extract at least one recommended keyword by extracting a representative property of a predicate and a representative type of an object among words included in the plurality of found triple data, and by processing the plurality of triple data.

For each of the extracted at least one recommended keyword, the calculation unit 140 may calculate a weight value, and the providing unit 150 may arrange the at least one recommended keyword based on the calculated weight value and may provide the user with the at least one recommended keyword.

Since various forms of information are required by the semantic search for defining a meaning of a search keyword input from a user to understand the meaning, one or two keywords is insufficient for interpreting the meaning in the semantic search dissimilar to conventional keyword-based search. Accordingly, the various forms of information required for interpreting the meaning in the semantic search needs to be provided from an input keyword input from the user.

However, when a keyword is input in a form of a natural word or a large number of keywords are input, ambiguity may occur, making it difficult to interpret a meaning of the keyword. To improve efficiency of semantic search, recommending an appropriate search keyword may be necessary.

For example, when a user inputs a search keyword of “Ryu Seung Wan movie” to search for a “movie directed by Ryu Seung Wan”, a keyword-based search system provides, in response to the input, search results for both a keyword of “Ryu Seung Wan” and a keyword of “movie”, or either a keyword of “Ryu Seung Wan” or a keyword of “movie”.

In this case, the keyword-based search system provides search results for a person with the same name, as well as search results for “Ryu Seung Wan” desired by the user, and also provides search results mapped to a keyword “movie”, even including search results irrelevant to the intent of the user.

However, a semantic search system according to an exemplary embodiment may provide search results for “movie” in relationships with “Ryu Seung Wan” and “direct”, “act”, and “write”, by interpreting a relation between “Ryu Seung Wan (film director)” and “movie”.

When an input keyword, in this example, “Ryu Seung Wan movie”, is interpreted through various relationships, the semantic search system may provide the user with all search results for “Ryu Seung Wan direct movie”, “Ryu Seung Wan act movie”, and “Ryu Seung Wan write movie”. Among the search results, the user may navigate and obtain search results consistent with the intent of the user. In this example, when the user inputs “Ryu Seung Wan direct movie”, more accurate search results may be provided.

Accordingly, the semantic search system may provide users accustomed to a keyword-based search system with accurate search results consistent with the intent of the users, by recommending an appropriate keyword contributing to an efficient semantic search.

According to an exemplary embodiment, to provide a user with a recommended keyword for the semantic search, more accurate search results may be provided as the user configures a search keyword to be greater compliance with a knowledge representation method specified in a knowledge base.

In this example, when the user inputs “Ryu Seung Wan” as an input keyword, an entity corresponding to the input keyword may be recognized in the knowledge base. When the entity corresponding to the input keyword “Ryu Seung Wan” is found in the knowledge base, a search may be conducted on a semantic network connected to the entity, and possible recommended keywords, for example, “Ryu Seung Wan direct movie”, “Ryu Seung Wan act movie”, and “Ryu Seung Wan write movie”, may be provided to the user.

The user may select a most suitable search keyword corresponding to the intent of the user among the provided recommended keywords and thus, be provided with accurate search results. The recommended keyword may be provided in a dependent form on a schema or a domain of the knowledge base. Accordingly, various types of recommended keywords may be provided based on a structure of the knowledge base.

Recently, web ontology language (OWL) endorsed by the World Wide Web Consortium (W3C) is being used as a most popular representation approach in the construction of a knowledge base. OWL may include classes, instances (individuals), and properties, for example, ObjectProperty and DatatypeProperty. Also, semantic networks in the knowledge base may be represented by triple data including a subject, a predicate, and an object.

For example, triple data of “Ryu Seung Wan” (subject)—“direct” (predicate)—“The unjust” (object) may be configured. Accordingly, for a recommended search keyword of “Ryu Seung Wan direct movie”, all instances of movies in a relationship between “Ryu Seung Wan” and “direct” may be provided as search results through entity recognition and semantic network search.

As shown in FIG. 1, when the user inputs an input keyword, the recognition unit 110 of the system 100 may recognize an entity corresponding to the input keyword in the knowledge base, and the search unit 120 may search for a plurality of triple data associated with the recognized entity.

The extraction 130 may extract at least one recommended keyword by processing the plurality of triple data, the calculation 140 may calculate a weight value for each of the at least one recommended keyword, and the providing unit 150 may arrange the at least one recommended keyword based on the calculated weight value and may provide the user with the at least one recommended keyword.

FIG. 2 is a flowchart illustrating a method of recommending a keyword according to an exemplary embodiment.

Referring to FIG. 2, in operation 210, when a user inputs an input keyword to a system according to an exemplary embodiment, the system may receive the input keyword.

The method of recommending a keyword according to an exemplary embodiment is in contrast to a conventional keyword-based search in which all possible keywords are provided in response to an input of, for example, “Ryu”. According to an exemplary embodiment, the input keyword may be input from the user in at least an entity recognizable form. Accordingly, when the user inputs, for example, “Ryu Seung Wan” as an input keyword and further inputs a space, a subsequent operation may proceed.

In operation 220, when the system receives the input keyword, the system may recognize an entity corresponding to the input keyword through entity recognition in a knowledge base.

The entity recognition according to an exemplary embodiment may correspond to mapping the search keyword input from the user to an actual entity in the knowledge base. That is, an identification (ID) of the actual entity in the knowledge base may be obtained by retrieving the input keyword from a previously generated label index in the knowledge base.

The label index in the knowledge base according to an exemplary embodiment may correspond to a previously generated index in the knowledge base when the knowledge base is loaded at the start-up of the system, and may include index information for labels and IDs of all the entities in the knowledge base. In a case in which two entities having a label “Kim Soo Hyun”, for example, “Kim Soo Hyun (writer)” and “Kim Soo Hyun (actor)” are present in the knowledge base, when the user inputs “Kim Soo Hyun”, the label index may return IDs of the two entities.

In operation 230, all triple data may be searched for in the knowledge base from the recognized entity. The triple data may include a subject, a predicate, and an object. When a search for all triple data is conducted in the knowledge base from the recognized entity corresponding to the input keyword, for example, “Ryu Seung Wan”, all triple data may be obtained as shown in the following Table 1.

TABLE 1

| Triple data | Recommended keyword |
|---|---|
| Ryu Seung Wan-directs-The Unjust | Ryu Seung Wan-direct-movie |
| Ryu Seung Wan-writes-The Unjust | Ryu Seung Wan-write-movie |
| Ryu Seung Wan-produces- | Ryu Seung Wan-produce-movie |
| Troubleshooter | |
| Ryu Seung Wan-writes-Troubleshooter | Ryu Seung Wan-write-movie |
| Ryu Seung Wan-has a cameo in- | Ryu Seung Wan-act-movie |
| Battlefield Heroes | |
| Ryu Seung Wan-has a cameo in-Mama | Ryu Seung Wan-act-movie |
| Ryu Seung Wan-directs-The City of | Ryu Seung Wan-direct-movie |
| Violence | |
| Ryu Seung Wan-writes-The City of | Ryu Seung Wan-write-movie |
| Violence | |
| Ryu Seung Wan-stars in-The City of | Ryu Seung Wan-act-movie |
| Violence | |
| Ryu Seung Wan-directs-Crying Fist | Ryu Seung Wan-direct-movie |
| Ryu Seung Wan-writes-Crying Fist | Ryu Seung Wan-write-movie |
| Ryu Seung Wan-directs-Arahan | Ryu Seung Wan-direct-movie |
| Ryu Seung Wan-writes-Arahan | Ryu Seung Wan-write-movie |
| Ryu Seung Wan-has a cameo in- | Ryu Seung Wan-act-movie |
| Sympathy for Lady Vengeance | |
| Ryu Seung Wan-directs-No Blood No | Ryu Seung Wan-direct-movie |
| Tears | |
| Ryu Seung Wan-writes-No Blood No | Ryu Seung Wan-write-movie |
| Tears | |
| Ryu Seung Wan-plays an extra in- | Ryu Seung Wan-act-movie |
| Sympathy for Mr. Vengeance | |
| Ryu Seung Wan-directs-Dachimawa | Ryu Seung Wan-direct-movie |
| Lee | |
| Ryu Seung Wan-directs-Hey Man | Ryu Seung Wan-direct-movie |

In operation 240, the system may find a representative property of a predicate and a representative type of an object in the plurality of triple data, and generate a recommended keyword list.

According to an exemplary embodiment, the system may extract the representative property corresponding to the predicate, for example, direct, write, act, and produce, and the representative type corresponding to the object, for example, movie, from the plurality of obtained triple data. Also, the system may generate the recommended keyword list shown in Table 1 from the extracted representative property and the extracted representative type.

In operation 250, the calculation unit may calculate a weight value for the generated recommended keyword based on the knowledge base, and in operation 260, may arrange the recommended keyword based on the calculated weight value. The calculation unit may calculate the weight value for the recommended keyword based on a number of appearances of the recommended keyword.

In this example, the weight value may be calculated based on a number of appearances of recommended search keywords for all triple data of a corresponding instance. Referring to Table 1 as an example, a weight value corresponding to “direct” may be 7/19, a weight value corresponding to “write” may be 6/19, and a weight value corresponding to “produce” may be 1/19. This weight value may be a basis for determining whether “Ryu Seung Wan” plays an active part as a film director or an actor. Accordingly, when the recommended keyword is arranged based on the weight value, the system may rank the recommended keyword in an order of “Ryu Seung Wan—direct—movie”, “Ryu Seung Wan—write—movie”, and “Ryu Seung Wan—produce—movie”.

In operation 270, the system may provide the user with the recommended keyword in a form of an array. The user may be provided with an accurate search service by selecting a keyword consistent with the intent of the user among the provided recommended keyword.

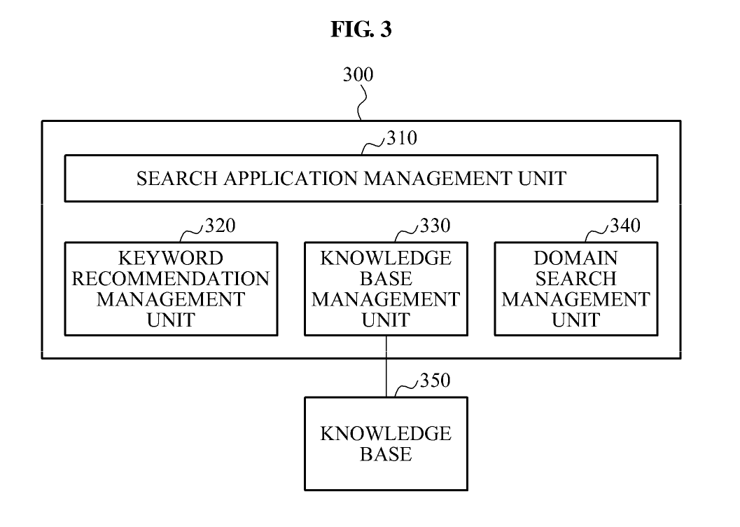

FIG. 3 is a diagram illustrating an entire configuration of a keyword recommendation system 300 according to an exemplary embodiment.

Referring to FIG. 3, the keyword recommendation system 300 according to an exemplary embodiment may include a search application management unit 310, a keyword recommendation management unit 320, a knowledge base management unit 330, a domain search management unit 340, and a knowledge base 350. The search application management unit 310 may provide a user with a search application. The keyword recommendation management unit 320 may recommend a search keyword based on a search keyword input partially from the user. The knowledge base management unit 330 may search the knowledge base 350 with the received search keyword in response to a search instruction from the user, may interpret a meaning of the keyword, and may produce a result. The domain search management unit 340 may receive a result of the meaning interpretation from the search application management unit 310 and may transmit the result to each search engine to conduct an actual search.

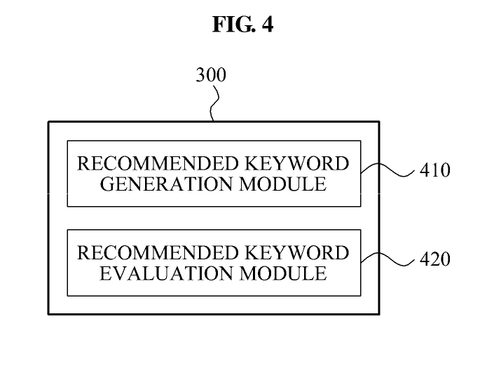

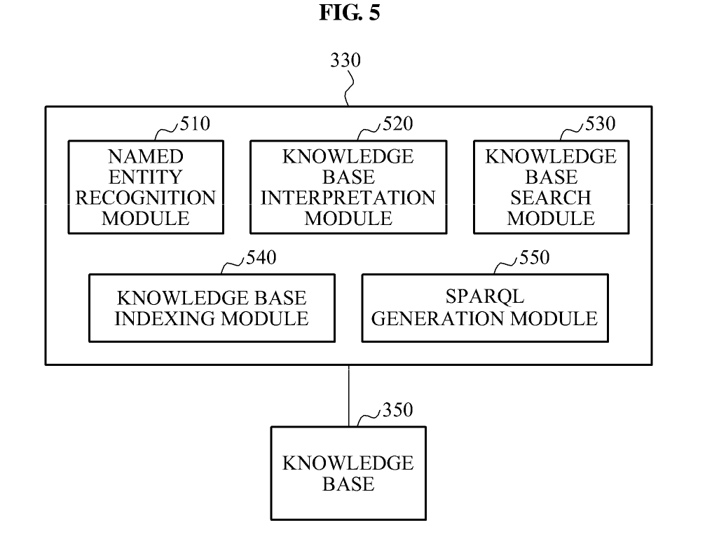

The search application management unit 310 may provide a user with a search application, may receive a search keyword from the user through the search application, and may transmit the received search keyword to the keyword recommendation management unit 320 and the knowledge base management unit 330. Also, the search application management unit 310 may render and provide the user with a recommended search keyword or search results. A further detailed description of the system 300 is provided with reference to FIGS. 4 and 5.

FIG. 4 is block diagram illustrating the keyword recommendation management unit 320 of the system 300 of FIG. 3.

As described in the foregoing, the keyword recommendation management unit 320 may provide the recommended search keyword based on the search keyword input partially from the user.

Referring to FIG. 4, the keyword recommendation management unit 320 may include a recommended keyword generation module 410 and a recommended keyword evaluation module 420.

The recommended keyword generation module 410 may recognize an entity corresponding to the search keyword input partially from the user through a named entity recognition module described in the following, and may generate a candidate recommended search keyword from the recognized entity. The recommended keyword evaluation module 420 may evaluate and rank the candidate recommended search keyword generated by the recommended keyword generation module 410, based on the knowledge base.

FIG. 5 is block diagram illustrating the knowledge base management unit 330 of the system 300 of FIG. 3.

Referring to FIG. 5, the knowledge base management unit 330 may include a named entity recognition module 510, a knowledge base interpretation module 520, a knowledge base search module 530, a knowledge base indexing module 540, and a SPARQL generation module 550. The knowledge base management unit 330 may be connected to the knowledge base 350.

The knowledge base indexing module 540 may load the knowledge base 350 at the start-up of the system 300, and may generate an index for an entity and a label in the knowledge base 350. The generated index may be used by the named entity recognition module 510.

The named entity recognition module 510 may recognize an entity corresponding to the search keyword in the knowledge base 350 based on the index of the knowledge base, and the knowledge base interpretation module 520 may search a semantic network of the knowledge base 350 based on a result of the entity recognition and may produce a result of meaning interpretation.

The SPARQL generation module 550 may transform the result of meaning interpretation into a SPARQL query that may allow for a query to the knowledge base 350, and the knowledge base search module 530 may place a query with SPARQL to produce a search result.

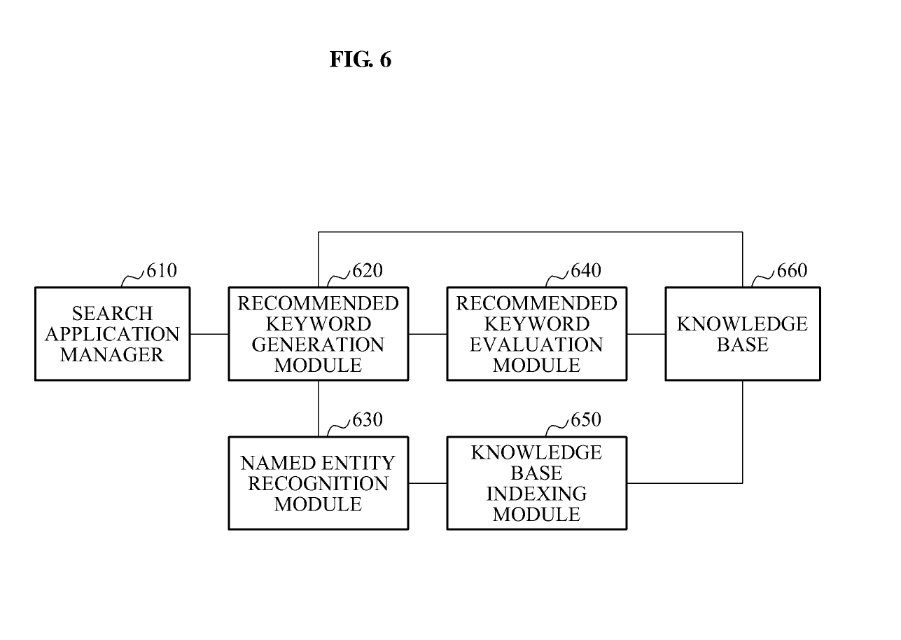

FIG. 6 is a block diagram for recommending a keyword according to an exemplary embodiment.

Referring to FIG. 6, a knowledge base 660 may be loaded at the start-up of a system, and may be designed to generate an index for an entity and a label. The search application manager 610 may receive a search keyword input partially from a user, and may transmit the received search keyword to the recommended keyword generation module 620.

The recommended keyword generation module 620 may request entity recognition by transmitting the keyword to the named entity recognition module 630. The named entity recognition module 630 may obtain an entity ID having a label for the corresponding keyword through the knowledge base indexing module 650. Also, the named entity recognition module 630 may configure a result of entity recognition from the obtained entity ID, and may transmit the result of entity recognition to the recommended keyword evaluation module 640.

Also, the named entity recognition module 630 may obtain all triple data having the corresponding entity as a subject by searching the knowledge base 660 from the result of entity recognition, may extract a representative property of a predicate and a representative type of an object by analyzing the obtained triple data, and may generate a candidate recommended keyword. The generated candidate recommended keyword may be transmitted to the recommended keyword evaluation module 640.

The recommended keyword evaluation module 640 may obtain a weight value based the knowledge base 660 to evaluate the candidate recommended keyword, and may rank the candidate recommended keyword based on the weight value.

Also, the recommended keyword evaluation module 640 may transmit the evaluated candidate recommended keyword to the recommended keyword generation module 620. The recommended keyword generation module 620 may transform the ranked candidate recommended keyword into a label that may be understood by the user, to generate a recommended keyword, and transmit the generated recommended keyword to the search application manager 610.

The search application manager 610 may render and provide the recommended keyword to the user.

In the semantic search, interpreting a meaning of a user search keyword with an aim to provide accurate search results is a difficult task. Further, interpreting a search intent of a user is also difficult. Conventional semantic search produces search results by recognizing an entity from a user search keyword, searching a semantic network, configuring all possible query graphs, evaluating the plurality of query graphs, and selecting query graph a most consistent with the intent of the user.

Evaluating and ranking the plurality of query graphs is a very difficult technique because a query graph generated from an ambiguous keyword input from a user is provided in numerous of types, ranking a plurality of query graphs is very difficult.

To provide a user with a more accurate search result, the keyword recommendation method may recommend a suitable search keyword, may receive a feedback from the user, may search for query graphs, and may rank the query graphs, resulting in a reduction of costs.

Additionally, users accustomed to keyword-based search have difficulties in configuring a suitable keyword for a semantic search system. In a case in which semantic search is dependent on a structure of a knowledge base, writing a suitable semantic search keyword is difficult.

Accordingly, the keyword recommendation method may allow users accustomed to keyword-based search to use a semantic search system efficiently by providing a recommended keyword. Also, with the diversity of devices, for example, smart phones, smart TVs, and the like, the keyword recommendation method may provide a recommended keyword for semantic search in an environment of a device-based information search that is more inconvenient to input than PC-based information search, so that a user may use a convenient semantic search environment by inputting minimal information and receiving a feedback.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A keyword recommendation system comprising:
a recognition unit to recognize an entity corresponding to an input keyword from a user;
a search unit to search for a plurality of triple data associated with the entity;
an extraction unit to extract at least one recommended keyword by processing the plurality of triple data; and
a providing unit to provide the at least one recommended keyword.

2. The keyword recommendation system of claim 1, further comprising:
a calculation unit to calculate a weight value for the at least one recommended keyword,
wherein the providing unit provides the at least one recommended keyword by arranging the at least one recommended keyword based on the calculated weight value.

3. The keyword recommendation system of claim 2, wherein the calculation unit calculates the weight value based on a number of appearances of the at least one recommended keyword.

4. The keyword recommendation system of claim 1, wherein the recognition unit recognizes the entity corresponding to the input keyword by referring to label index information stored in a knowledge base for the system.

5. The keyword recommendation system of claim 1, wherein the search unit searches for a plurality of triple data having the entity as a subject among a plurality of triple data stored in a knowledge base for the system.

6. The keyword recommendation system of claim 5, wherein the plurality of triple data comprises a subject, a predicate, and an object, and
the search unit searches for a plurality of triple data having an identical subject to the entity among the plurality of triple data stored in the knowledge base.

7. The keyword recommendation system of claim 1, wherein the extraction unit processes the plurality of triple data by extracting a representative property of a predicate among words included in the plurality of triple data.

8. The keyword recommendation system of claim 1, wherein the extraction unit processes the plurality of triple data by extracting a representative type of an object among words included in the plurality of triple data.

9. A keyword recommendation method comprising:
receiving an input keyword from a user;
recognizing an entity corresponding to the input keyword;
searching for a plurality of triple data associated with the recognized entity;
extracting at least one recommended keyword by processing the plurality of triple data;
calculating a weight value for the at least one recommended keyword; and
providing the at least one recommended keyword.

10. The keyword recommendation method of claim 9, wherein the recognizing of the entity comprises recognizing the entity corresponding to the input keyword by referring to label index information stored in a knowledge base.

11. The keyword recommendation method of claim 9, wherein the calculating of the weight value comprises calculating the weight value based on a number of appearances of the at least one recommended keyword.

12. The keyword recommendation method of claim 9, wherein the providing of the at least one recommended keyword further comprises arranging the at least one recommended keyword based on the calculated weight value.

13. The keyword recommendation method of claim 9, wherein the plurality of triple data stored in the knowledge base comprises a subject, a predicate, and an object, and
the searching for the plurality of triple data comprises searching for, among a plurality of triple data stored in a knowledge base, a plurality of triple data having the entity as a subject, and searching for a plurality of triple data having an identical subject to the entity.

14. The keyword recommendation method of claim 9, wherein the extracting of the at least one recommended keyword comprises processing the plurality of triple data by extracting a representative property of a predicate and a representative type of an object among words included in the plurality of triple data.
